(19) United States
(12) Patent Application Publication
(10) Pub. No.: US 2010/0226324 A1
(43) Pub. Date: Sep. 9, 2010

(54) METHOD OF TRANSMITTING CONTROL SIGNALS IN WIRELESS COMMUNICATION SYSTEM

(76) Inventors: Hyun Woo Lee, Gyeongki-do (KR); Seung Hee Han, Gyeongki-do (KR); Min Seok Noh, Gyeongki-do (KR); Jin Sam Kwak, Gyeongki-do (KR); Dong Cheol Kim, Gyeongki-do (KR); Yeong Hyeon Kwon, Gyeongki-do (KR); Dragan Vujcic, Gyeongki-do (KR)

Correspondence Address: MCKENNA LONG & ALDRIDGE LLP, 1900 K STREET, NW, WASHINGTON, DC, 20006, US

(21) Appl. No.: 12/680,672

(22) PCT Filed: Oct. 7, 2008
(86) PCT No.: PCT/KR08/05863

§ 371 Date: Mar. 29, 2010

(30) Foreign Application Priority Data
Oct. 8, 2007 (KR) 10-2007-0101132

(51) Int. Cl. H04W 72/00

(52) U.S. Cl. 370/329

(57) ABSTRACT

A method of transmitting a control signal includes transmitting a random access preamble on a random access channel (RACH) resource in a subframe, wherein the RACH resource includes a preamble period which is a time for transmitting the random access preamble and a cyclic prefix (CP) period which is a time for transmitting a CP, and transmitting a sounding signal on a single carrier-frequency division multiple access (SC-FDMA) symbol subsequent to the RACH resource in the subframe.

### TECHNICAL FIELD

The present invention relates to wireless communications, and more particularly, to a method of transmitting control signals in a wireless communication system.

### BACKGROUND ART

Wireless communication systems are widely spread all over the world to provide various types of communication services such as voice or data. In general, the wireless communication system is a multiple access system capable of supporting communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, etc.

An orthogonal frequency division multiplexing (OFDM) system is a system capable of reducing inter-symbol interference with a low complexity. In the OFDM system, serial input data symbols are converted into N parallel data symbols and are carried and transmitted on separate N subcarriers. The subcarriers maintain orthogonality in a frequency dimension. Orthogonal channels experience mutually independent frequency selective fading, and thus inter-symbol interference can be minimized. OFDMA is a multiple access scheme in which the multiple-access is achieved by independently providing some of available subcarriers to a plurality of users when using a system which employs the OFDM as a modulation scheme. In the OFDMA, frequency resources (i.e., subcarriers) are provided to the respective users, and the respective subcarriers are independently provided to the plurality of users. Thus, the subcarriers generally do not overlap with one another. Eventually, the frequency resources are mutually exclusively allocated to the respective users.

While having almost the same complexity with the OFDMA, SC-FDMA has a lower peak-to-average power ratio (PAPR) due to a single carrier property. Since the kw PAPR is advantageous for a user equipment (UE) in terms of transmission power efficiency, the SC-FDMA is adopted for uplink transmission in a 3rd generation partnership project (3GPP) long term evolution (LTE) as disclosed in section 5 of 3GPP TS 36.211 V8.0.0 (2007-09) “Technical Specification Group Radio Access Network; Evolved Universal Terrestrial Radio Access (E-UTRA); Physical channels and modulation (Release 8)”

In general, there are one or more cells within the coverage of a base station (BS). One cell may include a plurality of UEs. A UE is generally subjected to a random access procedure to access a network. The random access procedure can be used so that the UE is synchronized with the network or the UE requests uplink radio resources. In the random access procedure, a random access channel (RACH) is used as an uplink channel for transmitting a random access preamble from the UE to the network.

An RACH resource used for RACH transmission generally occupies a large portion in a frequency and time domain. For example, the RACH resource may occupy a portion of 1.08 mega hertz (MHz) in the frequency domain and a portion of 1 millisecond (ms) in the time domain. Further, a plurality of RACH resources can be defined in the frequency domain, and can be transmitted during 2 to 3 ms in the time domain according to a cell size. Since interference may occur when the RACH is transmitted simultaneously with other control signals by using the same resource, interference needs to be taken into account in the allocation of the RACH resources. This is because a network access may be delayed due to the occurrence of interference in the RACH, which may lead to a service delay.

As such, a large amount of RACH resources under a limited resource condition results in the decrease of resources required to transmit other signals. In particular, in case of a wireless communication system using a small frequency band or in case of a system having a large cell radius, radio resources required to transmit other control signals may be further significantly reduced due to the RACH resources.

Accordingly, there is a need for a method of effectively using resources for an RACH and resources for other control signals while reducing interference between the RACH and the control signals.

### DISCLOSURE OF INVENTION

### Technical Problem

The present invention provides an apparatus and method for reducing interference between control signals.

### Technical Solution

In an aspect, a method of transmitting a control signal in a wireless communication system includes transmitting a random access preamble on a random access channel (RACH) resource in a subframe, wherein the RACH resource includes a preamble period which is a time for transmitting the random access preamble and a cyclic prefix (CP) period which is a time for transmitting a CP, and transmitting a sounding signal on a single carrier-frequency division multiple access (SC-FDMA) symbol subsequent to the RACH resource in the subframe.

The sounding signal may be transmitted in a last SC-FDMA symbol of the subframe. The subframe may include the RACH resource and a guard period. The sounding signal may be transmitted on the SC-FDMA symbol within the guard period.

In another aspect, an apparatus for wireless communication includes a radio frequency (RF) unit for transmitting a radio signal, and a processor coupled with the RF unit and configured to transmit a random access preamble on an RACH resource in a subframe, wherein the RACH resource includes a preamble period which is a time for transmitting the random access preamble and a CP period which is a time for transmitting a CP, and transmit a sounding signal on an SC-FDMA symbol not overlapping with the RACH resource in the subframe.

### ADVANTAGEOUS EFFECTS

Other control information can be transmitted during a time subsequent to a random access channel (RACH) resource. Therefore, interference between control signals is reduced, and limited radio resources can be further effectively used.

### BRIEF DESCRIPTION OF THE DRAWINGS

FIG. 1 shows a structure of a wireless communication system.

FIG. 2 is a diagram showing a control plane of a radio interface protocol.

FIG. 3 is a diagram showing a user plane of a radio interface protocol.

FIG. 4 shows a structure of a radio frame in a 3rd generation partnership project (3GPP) long term evolution (LTE).

FIG. 5 shows an example of a resource grid for one uplink slot.

FIG. 6 shows an example of a random access channel (RACH) resource.

FIG. 7 shows another example of an RACH resource.

FIG. 8 shows a method of transmitting a control signal according to an embodiment of the present invention.

FIG. 9 shows a method of transmitting a control signal according to another embodiment of the present invention.

FIG. 10 shows a method of transmitting a control signal according to another embodiment of the present invention.

FIG. 11 shows a data transmission method using an RACH according to another embodiment of the present invention.

FIG. 12 is a flow diagram showing a random access procedure according to an embodiment of the present invention.

FIG. 13 is a flowchart showing a method of transmitting a control signal according to an embodiment of the present invention.

FIG. 14 is a block diagram showing an apparatus for wireless communication according to an embodiment of the present invention.

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink.

For clarity, the following description will focus on the 3GPP LTE. However, the technical features of the present invention are not limited thereto.

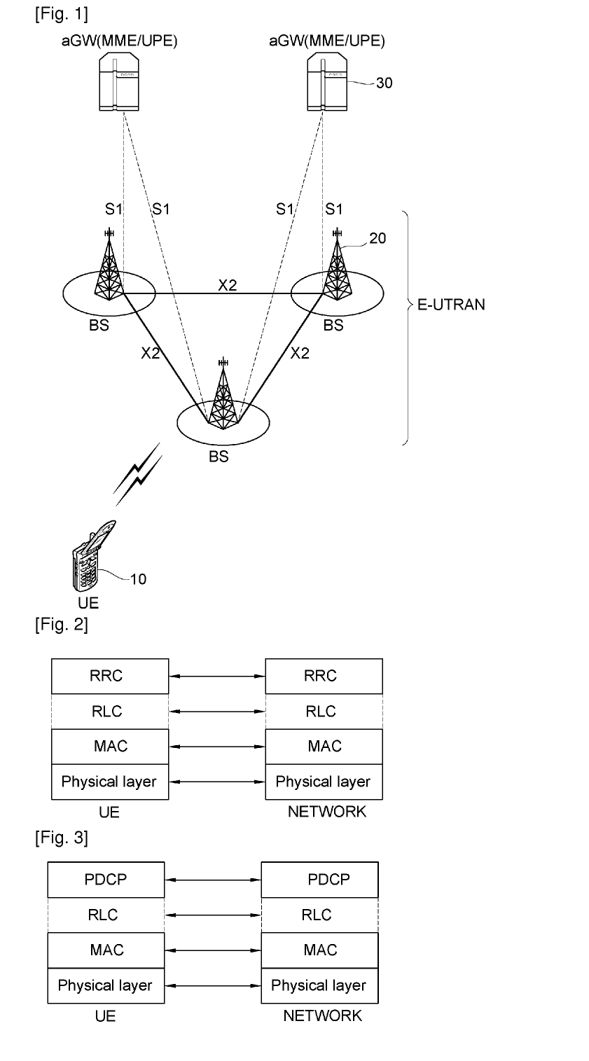

FIG. 1 shows a structure of a wireless communication system. The wireless communication system may have a network structure of an E-UMTS. The E-UMTS may be referred to as an LTE system. The wireless communication system can be widely deployed to provide a variety of communication services, such as voices, packet data, etc.

Referring to FIG. 1, an evolved-UMTS terrestrial radio access network (E-UTRAN) includes at least one base station (BS) 20. A user equipment (UE) 10 may be fixed or mobile, and may be referred to as another terminology, such as a mobile station (MS), a user terminal (UT), a subscriber station (SS), a wireless device, etc. The BS 20 is generally a fixed station that communicates with the UE 10 and may be referred to as another terminology, such as an evolved node-B (eNB), a base transceiver system (BTS), an access point, etc. There are one or more cells within the coverage of the BS 20. Interfaces for transmitting user traffic or control traffic can be used between BSs 20. Hereinafter, a downlink denotes a communication link from the BS 20 to the UE 10, and an uplink denotes a communication link from the UE 10 to the BS 20.

The BS 20 provides the UE 10 with an end-to-end point of a user plane and a control plane. The BSs 20 are interconnected by means of an X2 interface, and may have a meshed network structure in which the X2 interface always exists between the neighboring BSs 20.

The BSs 20 are also connected by means of an S1 interface to an evolved packet core (EPC), more specifically, to an access gateway (aGW) 30. The aGW 30 provides an end-to-end point for a session and mobility management function of the UE 10. The S1 interface supports a many-to-many connection among a plurality of nodes between the BS 20 and the aGW 30. The aGW 30 can be classified into a part for processing user traffic and a part for processing control traffic. In this case, for inter-communication, a new interface may be used between an aGW for processing new user traffic and an aGW for processing control traffic. The aGW 30 is also referred to as a mobility management entity/user plane entity (MME/UPE).

Layers of a radio interface protocol between the UE and the network can be classified into L1 layer (a first layer), 12 layer (a second layer), and L3 layer (a third layer) based on the lower three layers of the open system interconnection (OSI) model that is well-known in a communication system. A physical layer belongs to the first layer and provides an information transfer service on a physical channel. A radio resource control (RRC) layer belongs to the third layer and serves to control radio resources between the UE and the network. The UE and the network exchange RRC messages via the RRC layer. The RRC layer may be located in network nodes (i.e., the BS 20, the aGW 30, etc.) in a distributed manner, or may be located only in the BS 20 or the aGW 30.

The radio interface protocol horizontally includes a physical layer, a data link layer, and a network layer, and vertically includes a user plane for data information transfer and a control plane for control signaling delivery.

FIG. 2 is a diagram showing a control plane of a radio interface protocol. FIG. 3 is a diagram showing a user plane of the radio interface protocol. In FIGS. 2 and 3, a structure of the radio interface protocol between a UE and an E-UTRAN is based on a 3GPP wireless access network standard.

Referring to FIGS. 2 and 3, a physical layer, i.e., a first layer, provides an upper layer with an information transfer service on a physical channel. The physical layer is coupled with a media access control (MAC) layer, i.e., an upper layer of the physical layer, via a transport channel. Data is transferred between the MAC layer and the physical layer on the transport channel. In addition, data is transferred between different physical layers, i.e., between physical layers of a transmitting side and a receiving side.

The MAC layer in a second layer provides services to a radio link control (RLC) layer, i.e., an upper layer of the MAC layer, via a logical channel. The RLC layer in the second layer supports reliable data transfer. Functions of the RLC layer can be implemented as a function block included in the MAC layer. In this case, as indicated by a dotted line, the RLC layer may not exist.

A packet data convergence protocol (PDCP) belonging to the second layer performs a header compression function. When transmitting an Internet protocol (IP) packet such as an IPv4 packet or an IPv6 packet, the header of the IP packet may contain relatively large and unnecessary control information. The PDCP layer reduces the header size of the IP packet so as to efficiently transmit the IP packet through a radio interface.

An RRC layer belonging to a third layer is defined only in the control plane. The RRC layer serves to control the logical channel, the transport channel, and the physical channel in association with configuration, reconfiguration, and release of radio bearers (RBs). The RB is a service provided by the second layer for data transmission between the UE and the E-UTRAN.

A downlink transport channel transmits data from the network to the UE. Examples of the downlink transport channel include a broadcast channel (BCH) for transmitting system information and a downlink-shared channel (DL-SCH) for transmitting user traffic or control messages. User traffic of downlink multicast or broadcast services or control messages can be transmitted on the DL-SCH or am additional downlink multicast channel (DL-MCH). An uplink transport channel transmits data from the UE to the network. Examples of the uplink transport channel include a random access channel (RACH) for transmitting initial control messages and an uplink-shared channel (UL-SCH) for transmitting user traffic or control messages.

Now, a random access procedure in which a UE transmits a random access preamble to a network will be described. The random access procedure is used when the UE is uplink synchronized with the network or when uplink radio resources need to be obtained. For example, it is assumed that the UE is powered on and intends to initially access to a new cell. For initial access, the UE is downlink synchronized and then receives system information from a BS to be accessed. After obtaining information regarding transmission of the random access preamble from the system information, the UE transmits the random access preamble to the BS. Upon receiving the random access preamble, the BS transmits to the UE a random access response including time alignment information and uplink radio resource allocation information. Then, the UE can transmit an RRC connection message to the BS by using the uplink radio resource.

For another example, it is assumed that an RRC connection is established between the UE and the BS. In this case, radio resources are allocated to the UE according to radio resource scheduling of the BS, and data of the UE is transmitted to the BS by using the allocated radio resources. However, if no more data remains in a buffer of the UE, the network no longer allocates uplink radio resources to the UE. This is because it is inefficient to allocate uplink radio resources to the UE which does not have data to be transmitted. When new data is stored in the buffer of the UE which does not have previously allocated radio resources, the UE requests the BS to provide uplink radio resources required to transmit the data by using the random access procedure.

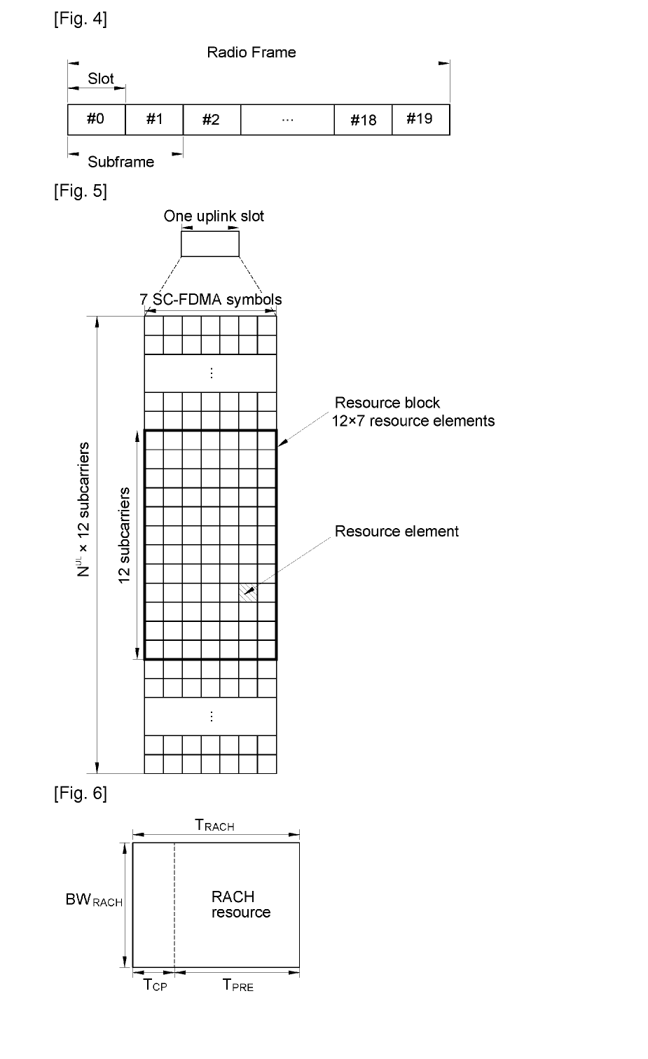

FIG. 4 shows a structure of a radio frame in a 3GPP LTE.

Referring to FIG. 4, a radio frame includes 10 subframes. One subframe includes two slots. A time for transmitting one subframe is defined as a transmission time interval (TTI). For example, one subframe may have a length of 1 millisecond (ms), and one slot may have a length of 0.5 ms.

One slot includes a plurality of SC-FDMA symbols in a time domain and a plurality of resource blocks (RBs) in a frequency domain. In the 3GPP LTE using the SC-FDMA symbol in uplink, the SC-FDMA symbol represents one symbol period. According to a system, the SC-FDMA symbol can also be referred to as an OFDMA symbol or a symbol period. The RB is a resource allocation unit, and includes a plurality of consecutive subcarriers in one slot.

The radio frame of FIG. 4 is shown for exemplary purposes only. Thus, the number of subframes included in the radio frame or the number of slots included in the subframe or the number of SC-FDMA symbols included in the slot may be modified in various manners.

FIG. 5 shows an example of a resource grid for one uplink slot.

Referring to FIG. 5, the uplink slot includes a plurality of SC-FDMA symbols in a time domain and a plurality of resource blocks (RBs) in a frequency domain. It is shown herein that one uplink slot includes 7 SC-FDMA symbols and one resource block includes 12 subcarriers. However, this is for exemplary purposes only, and thus the present invention is not limited thereto.

Each element of the resource grid is referred to as a resource element. One resource block includes 12×7 resource elements. The number N^{UL} of resource blocks included in the uplink slot is dependent on an uplink transmission bandwidth determined in a cell.

FIG. 6 shows an example of an RACH resource.

Referring to FIG. 6, a RACH resource is an unit for allocating an RACH in a time domain and/or a frequency domain. The RACH resource is a radio resource region on which a random access preamble is carried. A bandwidth BW_{RACH} of the RACH resource and an RACH period T_{RACH} can be defined to have specific sizes. For example, the bandwidth of the RACH resource may include six resource blocks (RBs). The RB is a basic unit of radio resources allocated to a UE. The RB may include 12 consecutive subcarriers in the frequency domain. The RACH period T_{RACH} may differ according to a cell size. The RACH period may be greater or less than a subframe length. For example, if a cell radius is 14.1 kilometers (km), the RACH period T_{RACH} of the RACH resource can be 1 TTI, and if the cell radius is 100 km, the RACH period T_{RACH} of the RACH resource can be 3 TTIs.

The RACH period T_{RACH} includes a cyclic prefix (CP) period T_{CP} and a preamble period T_{PRE}. The CP period T_{CP} is a time required to transmit a CP for minimizing inter-symbol interference or interference caused by a multi-path channel. The CP period is generally defined by considering a maximum delay spread of a channel and a round trip delay depending on a cell size to be supported. The preamble period T_{PRE} is PRE a time required to transmit a sequence of the random access preamble.

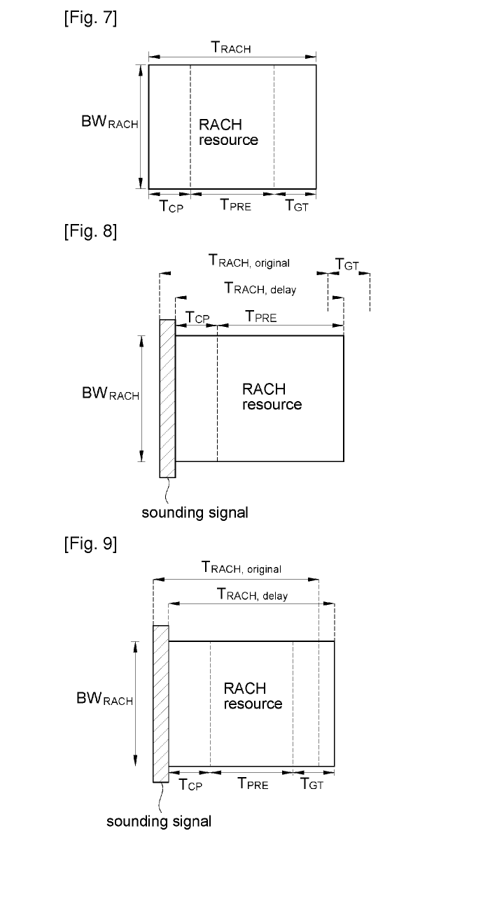

FIG. 7 shays another example of an RACH resource.

Referring to FIG. 7, an RACH period T_{RACH} of the RACH resource includes a CP period T_{CP}, a preamble period T_{PRE}, and a guard period T_{GT}. The guard period T_{GT} denotes an interval between a current slot and a temporally subsequent slot (or subframe), and is generally defined by considering a round trip delay depending on a cell size to be supported. The guard period T_{GT} may be generally equal to or greater than a period of one SC-FDMA symbol (or SC-FDMA symbol). When transmitted, the guard period T_{GT} may carry no signal, and is generally not used in a detection process of a receiver. In a downtown area having a small cell radius, system performance is almost not affected by the decrease in the size of the guard period T_{GT}.

Limited radio resources can be further effectively used by transmitting other control signals within the guard period TGT. In addition, subsequent to the RACH resource described in FIG. 6, a second guard period having a specific size can be defined to avoid interference with another slot. Other control information can be transmitted using the second guard period.

FIG. 8 shows a method of transmitting a control signal according to an embodiment of the present invention. This is a case where other control information is transmitted simultaneously with or independently from a random access preamble by using a delay indicator indicating a delay of an RACH period in the RACH resource of FIG. 6. Transmission of the random access preamble and other control information may be achieved in different UEs or in the same UE. However, a BS simultaneously receives two signals.

Referring to FIG. 8, a start point of the RACH resource can be delayed by a specific time by using the delay indicator. That is, the delay indicator can be used to transmit a random access preamble in a delayed RACH period T_{RACH,delay} delayed by a specific time from an original RACH period T_{RACH,original}. For example, the delay indicator can be expressed with 1 bit so that the random access preamble is transmitted in the original RACH period T_{RACH,original} if the delay indicator is ‘0’, and the random access preamble is transmitted in the delayed RACH period T_{RACH,delay} if the delay indicator is ‘1’. Whether the random access preamble transmitted by a UE is delayed or not in transmission can be determined by the UE, and then the UE can report the determination result to a BS. Alternatively, the BS may determine a transmission time of the random access preamble to be transmitted with a delay according to a cell size, and then can report the determination result to the UE.

Other control signals can be transmitted by other UEs which have already obtained synchronization on a previous resource region due to a delay of the random access preamble. A specific period generated as a result of delayed transmission of the random access preamble may correspond to at least one SC-FDMA symbol. Even if the random access preamble is not delayed by the size of one SC-FDMA symbol in one subframe, other control signals can be transmitted on a first SC-FDMA symbol of the subframe. In this case, a sounding signal can be transmitted on an SC-FDMA symbol generated due to the delay of the random access preamble. That is, an RACH is delayed by the size of a single SC-FDMA symbol in transmission, and the sounding signal is transmitted on the single SC-FDMA symbol generated as a result of the delayed transmission. The sounding signal is a reference signal for uplink scheduling. By allowing the sounding signal to be transmitted simultaneously with the random access preamble, uplink scheduling can be easily performed and capacity within a cell can be increased.

The sounding signal is transmitted on an SC-FDMA symbol (or OFDMA symbol) which is temporally prior to the RACH resource. The SC-FDMA symbol may not overlap with the RACH resource or may overlap with a part of the RACH resource. To avoid overlapping with the RACH resource, the sounding signal can be transmitted on the first SC-FDMA symbol of the subframe. The sounding signal is for exemplary purposes only, and thus another control signal may be transmitted instead of the sounding signal. In this case, UEs can know whether the RACH resources are delayed by using the delay indicator.

Even if the random access preamble is transmitted with a delay of a specific time, mutual interference does not occur as long as the RACH resource exists within a guard period. In general, the guard period has a size equal to or greater than one SC-FDMA symbol, and thus interference does not occur even if the RACH is delayed by the size of one SC-FDMA symbol. Since this is a case where the size of the guard period is actually decreased, a cell coverage of the BS can be decreased. However, even if the size of the guard period is decreased, system performance is almost not affected in a BS (e.g., hot spot BS) using a small cell radius such as in a downtown area. In addition, the delay time may be set to be less than one SC-FDMA symbol period by considering the decreased cell coverage. In this case, a larger cell coverage can be supported, but performance deterioration may occur since control signals can overlap with the random access preamble in transmission.

The time for transmitting the random access preamble with a delay, the control signal transmitted together with the random access preamble, and the number of bits of the delay indicator are for exemplary purposes only, and thus the present invention is not limited thereto. The random access preamble can be transmitted with a delay corresponding to the size of several SC-FDMA symbols within a range not exceeding the guard period TGT. In the delayed transmission, a delay time does not need to be a multiple of the SC-FDMA symbol period. Various control signals can be transmitted on the SC-FDMA symbol generated as a result of delayed transmission of the random access preamble. Example of the various control signals include a reference signal for data demodulation, an acknowledgement (ACK)/not-acknowledgement (NACK) signal for hybrid automatic repeat request (HARQ), a channel quality indicator (CQI) indicating a downlink channel condition, a precoding matrix indicator (PMI) indicating a precoding matrix, and a rank indicator (RI) indicating a rank, etc. The number of bits of the delay indicator may have a size of several bits. The delay indicator can indicate a variety of information such as the number of SC-FDMA symbols during which the random access preamble is delayed, a type of a control signal transmitted on the SC-FDMA symbol, etc.

FIG. 9 shows a method of transmitting a control signal according to another embodiment of the present invention. This is a case where a delay indicator is used when using the RACH resource defined in FIG. 7.

Referring to FIG. 9, even in a case where the RACH resource includes not only a CP period and a preamble period but also a guard period T_{GT}, a start point of the RACH resource can be delayed by a specific time by using the delay indicator. No signal is actually transmitted in the guard period T_{GT} even if the random access preamble is transmitted in a delayed RACH period T_{RACH,delay}. Therefore, a guard period portion exceeding an original RACH period T_{RACH,original} does not have an effect on a subsequently transmitted SC-FDMA symbol (or slot or subframe). Other UEs which have already obtained synchronization can transmit other control information or a sounding signal on the SC-FDMA symbol generated as a result of delayed transmission of the RACH resource.

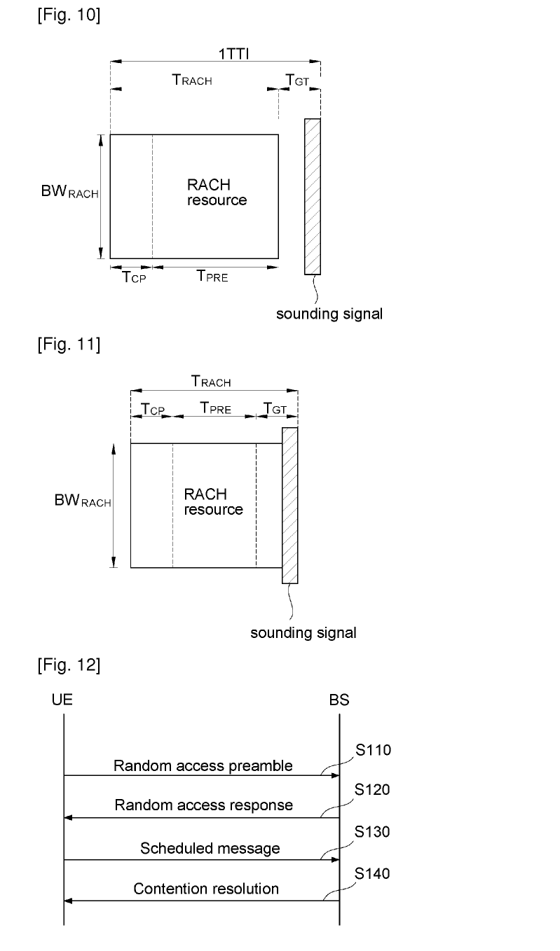

FIG. 10 shows a method of transmitting a control signal according to another embodiment of the present invention. This is a case where other control signals are transmitted on an SC-FDMA symbol subsequent to the RACH resource defined in FIG. 6.

Referring to FIG. 10, a sounding signal is transmitted on the SC-FDMA symbol subsequent to the RACH resource. The SC-FDMA symbol subsequent to the RACH resource denotes an SC-FDMA symbol which is temporally posterior to the RACH resource and which is contigous (or not contiguous) with the RACH resource. One UE may simultaneously transmit a random access preamble and the sounding signal within one subframe, or may independently transmit the random access preamble and the sounding signal in different frames. For example, the UE may transmit the random access preamble on an RACH resource within a first subframe, and may transmit the sounding signal on an SC-FDMA symbol belonging to a guard period within a second subframe. In addition, several UEs may transmit respective random access preambles and sounding signals in one subframe. For example, a first UE transmits a random access preamble in a subframe, and a second UE transmits the sounding signal in the same subframe. In this case, a BS can simultaneously receive the random access preamble and the sounding signal.

The sounding signal is transmitted in a guard period T_{GT} subsequent to an RACH resource within one or another subframe. At least one SC-FDMA symbol (or OFDMA symbol) can be included in the guard period. The sounding signal is transmitted on the SC-FDMA symbol belonging to the guard period. This is because the SC-FDMA symbol subsequent to the RACH resource is included in the range of the guard period when a subframe includes the RACH resource and the guard period. Since the guard period is located at a last portion of the subframe, the sounding signal can be prevented from overlapping with the RACH resource if the sounding signal is transmitted on a last SC-FDMA symbol of the subframe. The RACH resource and the guard period do not overlap with each other in the subframe. In general, the guard period T_{GT} has a size larger than one SC-FDMA symbol. The guard period T_{GT} transmits no actual signal, and is generally not used in a detection process of a receiver. Therefore, even if the sounding signal is transmitted, interference caused by the transmission of the random access preamble can be minimized. For example, in the E-UMTS, one SC-FDMA has a size of 66.67 microseconds (μs), and a guard period T_{GT} for the RACH resource is 97.4 μs. Thus, at least one SC-FDMA symbol can be included in the guard period T_{GT}.

The size of the guard period T_{GT} can be decreased due to transmission of the sounding signal (e.g., 97.4−66.67=30.73 μs). However, even if the size of the guard period T_{GT} is decreased, system performance is almost not affected in a BS using a small cell radius such as in a downtown area. Therefore, when the BS uses the small cell radius, the UE can simultaneously transmit the random access preamble and the sounding signal while reducing the size of the guard period T_{GT}.

If the size of the guard period is less than the size of one SC-FDMA symbol, or if the size of a region in which the RACH resource is excluded from one subframe is less than the size of one SC-FDMA symbol, the sounding signal can be transmitted on the last SC-FDMA symbol of the subframe to reduce interference between the RACH resource and the sounding signal. This means that the sounding signal is transmitted on a fixed location within the subframe, that is, on the last SC-FDMA symbol, irrespective of the size of the RACH resource.

FIG. 11 shows a data transmission method using an RACH according to another embodiment of the present invention. This is a case where other control signals are transmitted on an SC-FDMA symbol subsequent to the RACH resource defined in FIG. 7.

Referring to FIG. 11, if the RACH resource includes a guard period T_{GT}, a sounding signal can be transmitted on the SC-FDMA symbol subsequent to the RACH resource. In this case, the subsequent SC-FDMA symbol may be a last SC-FDMA symbol of a subframe. The last SC-FDMA symbol belongs to the guard period TGT, and thus carries no signal. As a result, interference with the random access preamble does not occur.

If the sounding signal is transmitted in the guard period T_{GT}, an additional indicator is not required. This is because, by performing scheduling, a BS can know in advance that the sounding signal is transmitted in the guard period T_{GT}.

Although it has been described above that the RACH resource for transmitting the random access preamble has a structure in which the CP period and the preamble period are included, the RACH resource also can have other various structures. For example, the RACH resource may have various sizes and configurations such as an extended RACH format, an iterative RACH format, etc. The structure of the RACH resource is for exemplary purposes only. Thus, transmitting of other control information by using a guard period subsequent to the RACH resource (or not overlapping with the RACH resource) is also included in the technical features of the present invention.

FIG. 12 is a flow diagram showing a random access procedure according to an embodiment of the present invention.

Referring to FIG. 12, in step S110, a UE selects an arbitrary random access preamble and an arbitrary RACH resource from an available random access preamble set and RACH resources, and transmits the selected random access preamble on the selected RACH to a BS. In this case, another UE which has already obtained uplink synchronization can transmit a sounding signal on an SC-FDMA subsequent to the RACH resource. From the perspective of the BS, the sounding signal may be transmitted temporally prior or posterior to the random access preamble so that the sounding signal does not overlap with the random access preamble. If the sounding signal is temporally prior to the random access preamble, the random access preamble is transmitted with a delay of a specific time corresponding to an SC-FDMA symbol for transmitting the sounding signal. A delay indicator may indicate whether the random access preamble is transmitted with a delay. If the sounding signal is temporally posterior to the random access preamble, the sounding channel can be transmitted on an SC-FDMA symbol within a guard period subsequent to the RACH resource. If the BS uses a small cell radius, system performance is almost not affected even if the sounding signal is transmitted temporally adjacent to the random access preamble. The BS can perform uplink scheduling by using the sounding signal.

In step S120, the BS receives the random access preamble, and then transmits a random access response to the UE. The BS can receive the sounding signal together with the random access preamble. The BS can perform uplink scheduling by using the sounding signal. In this case, the uplink scheduling can be performed by considering all sounding signals received in another time/frequency domain in addition to the sounding signal received together with the random access preamble. The random access response includes a time advance (TA) and uplink radio resource allocation information for the transfer of a scheduled message to be described below. In addition, the random access response includes an index of the received random access response so that the UE can determine whether the random access response is for the UE. The random access response transmitted on a DL-SCH may be specified by a DL L1/L2 control channel indicated by a random access-radio network temporary identity (RA-RNTI).

In step S130, the UE receives the random access response, and then transmits the scheduled message according to the radio resource allocation information included in the random access response. The scheduled message may be an RRC connection request message.

In step S140, the BS receives the scheduled message from the UE, and then transmits a contention resolution message to the UE.

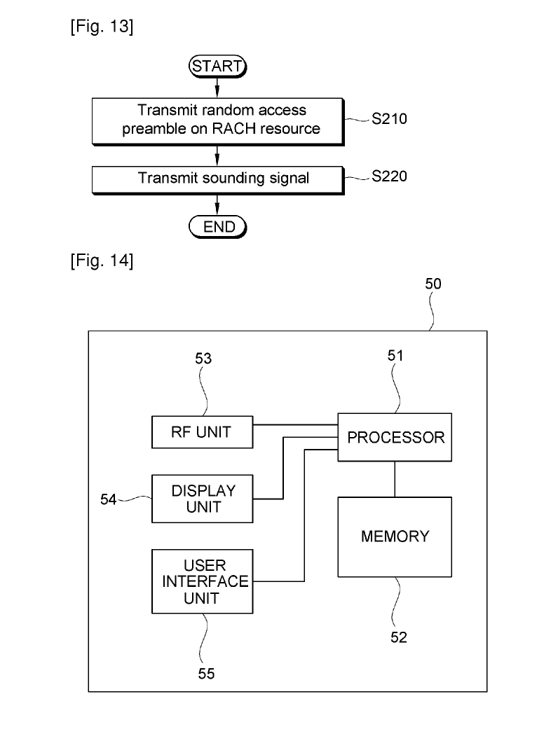

FIG. 13 is a flowchart showing a method of transmitting a control signal according to an embodiment of the present invention. In step S210, a UE transmits a random access preamble on an RACH resource within a subframe. The RACH resource includes a CP period and a preamble period. In step S220, the UE transmits a sounding signal on an SC-FDMA symbol subsequent to the RACH resource within the subframe. The SC-FDMA symbol may belong to the guard period within the subframe, or may be a last SC-FDMA symbol of the subframe.

FIG. 14 is a block diagram showing an apparatus for wireless communication according to an embodiment of the present invention. The apparatus may be a part of a UE. The apparatus 50 for wireless communication includes a processor 51, a memory 52, a radio frequency (RF) unit 53, a display unit 54, and a user interface unit 55. The memory 52 is coupled to the processor 51 and stores an operating system, applications, and general files. The display unit 54 displays a variety of information of the UE 50 and may use a well-known element such as a liquid crystal display (LCD), an organic light emitting diode (OLED), etc. The user interface unit 55 can be configured with a combination of well-known user interfaces such as a keypad, a touch screen, etc. The RF unit 53 is coupled to the processor 51 and transmits and/or receives radio signals. The processor 51 configures an RACH resource, and transmits a random access preamble and other control signals. The aforementioned embodiments can be performed by the processor 51.

All functions described above may be performed by a processor such as a micro-processor, a controller, a microcontroller, and an application specific integrated circuit (ASIC) according to software or program code for performing the functions. The program code may be designed, developed, and implemented on the basis of the descriptions of the present invention, and this is well known to those skilled in the art.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1-14. (canceled)

15. A method of transmitting a control signal in a wireless communication system, performed by a user equipment, comprising:
transmitting a orthogonal frequency division multiple access (OFDMA) symbol for a sounding signal in a subframe, the subframe comprising a plurality of OFDMA symbols in time domain,
wherein the transmission of the OFDMA symbol for the sounding signal is not overlapped with a transmission of a random access preamble in the subframe, and wherein the random access preamble comprises a time interval for transmitting a random access sequence and a cyclic prefix (CP) period which is a time interval for transmitting a CP of the random access preamble sequence within the subframe.

16. The method of claim 15, wherein the OFDMA symbol for the sounding signal is the last OFDMA symbol of the subframe.

17. The method of claim 15, wherein the position of the OFDMA symbol for the sounding signal in the subframe is fixed irrespective of the size of the random access preamble.

18. The method of claim 15, further comprising:
transmitting the random access preamble within the subframe; and
receiving a random access response including an index of the random access preamble and a time offset for uplink time correction.

19. The method of claim 18, wherein the random access preamble is transmitted by other user equipment.

20. An apparatus for wireless communication, comprising:
a radio frequency (RF) unit for transmitting a radio signal; and
a processor coupled with the RF unit and configured to:
transmit a orthogonal frequency division multiple access (OFDMA) symbol for a sounding signal in a subframe, the subframe comprising a plurality of OFDMA symbols in time domain,
wherein the transmission of the OFDMA symbol for the sounding signal is not overlapped with a transmission of a random access preamble in the subframe, and
wherein the random access preamble comprises a time interval for transmitting a random access sequence and a cyclic prefix (CP) period which is a time interval for transmitting a CP of the random access preamble sequence within the subframe.

21. The apparatus of claim 20, wherein the OFDMA symbol for the sounding signal is the last OFDMA symbol of the subframe.

22. The apparatus of claim 20, wherein the position of the OFDMA symbol for the sounding signal in the subframe is fixed irrespective of the size of the random access preamble.
